(19) United States
(12) Patent Application Publication
(10) Pub. No.: US 2009/0015424 A1
(43) Pub. Date: Jan. 15, 2009

(54) DEVICE AND METHOD FOR LOCATING MISSING PERSONS AND/OR OBJECTS

(76) Inventors: Peter Aust, Frankfurt (DE); Michael Aust, Frankfurt (DE)

Correspondence Address: JONES & SMITH, LLP, 2777 ALLEN PARKWAY, SUITE 800, HOUSTON, TX, 77019-2141, US

(21) Appl. No.: 11/596,822

(22) PCT Filed: Mar. 30, 2005
(86) PCT No.: PCT/EP2005/003291

§ 371 Date: Mar. 19, 2008

(30) Foreign Application Priority Data
May 17, 2004 (DE) 10 2004 024 778.1
Aug. 11, 2004 (DE) 10 2004 038 532.7

(51) Int. Cl. G08B 21/00

(52) U.S. Cl. 340/686.6

(57) ABSTRACT

This invention relates to a device for locating missing persons and/or objects, which device consists of at least one locator transmitter with a transceiver and at least one locator receiver which is designed as receiving transmitter and receives data telegrams sent from the transceiver and optically and/or acoustically displays the same as data enabling the locating. The invention further relates to a method for locating missing persons and/or objects, in which method at least one locator transmitter with a transceiver communicates in a wireless fashion with at least one locator receiver with a receiving transmitter and receives data telegrams sent from the transceiver and optically and/or acoustically displays the same as data enabling the locating. In order to design a device and a method in such a way that the aforementioned disadvantages are avoided and that the locating of missing persons and/or objects is made much easier and faster it is provided that the locator receiver (2) includes a transmitter (4) which for the activation of a particular locator transmitter (3) outputs a signal which activates the locator transmitter (3) to transmit the data telegram, with the transmitter (4) being adapted for manual operation at least if required, and that the locator transmitter (3) includes a particular individualized code (20) which is stored as data in the locator transmitter (3) and which is received by the locator receiver (2) after the activation of the transmitter (4) of the locator transmitter (3).

This invention relates to a device for locating missing persons and/or objects, which device consists of at least one locator transmitter with a transceiver and at least one locator receiver that is designed as a receiving transmitter and receives data telegrams transmitted from the transceiver and displaying these data optically and/or acoustically as data enabling said locating. The invention further relates to a method for locating missing persons and/or objects, in which method at least one locator transmitter with a transceiver communicates in a wireless fashion with at least one locator receiver with a receiving transmitter and receives data telegrams transmitted from the transceiver and displays these data optically and/or acoustically as data enabling said locating.

From prior art methods are known for locating missing persons which make it possible to locate persons with a high accuracy. These methods are generally based on the idea that the missing person carries a device which outputs a signal at a defined frequency. This signal can be located by means of a directional antenna and a suitable receiver. For this purpose devices are normally used which are operated by their manual activation through the user or by their automatic activation through particular environmental conditions such as heavy shocks, darkness (devices for locating avalanche victims) or the like. However, a substantial disadvantage is that the manual activation of these devices requires active cooperation of the person to be rescued. If the person to be rescued is unconscious and/or injured, there will be a risk that the device is not switched on, resulting in that it is not possible to locate the victim.

In devices which are automatically activated on the presence of particular environmental conditions, this happens without delay or staggered on the presence of said predetermined conditions. This is independent of the fact whether any search and rescue team is already on the site and available for locating the emitted signal. The consequence is that the energy resources which are necessary for the emission of the signal are possibly already exhausted by the time of the arrival of a search team at the scene of the accident. In this context there may be mentioned for instance the limited transmission time of flight recorders, the so-called black-boxes, which are able to emit a locating signal only for a defined period of time. If this period has expired, such a device cannot be located any longer. In addition, it can be assumed that the signal power decreases as the energy capacity decreases, whereby the locating is made difficult.

A further disadvantage of the pre-known methods and devices is that for instance in the case of avalanches burying a number of victims all the devices send signals at the same time, so that it is not possible to locate particular persons and due to the many signals which are emitted the locating cannot be effected accurately on the dot.

Starting from this prior art, the invention is based on the problem of designing a device and method in such a way that the above-mentioned disadvantages are avoided and that the locating of missing persons and/or objects is possible much easier and within a short time.

In a device according to the present invention the solution of this problem provides that the locator receiver includes a transmitter which for activating a particular locator transmitter sends a signal that activates the locator transmitter to transmit the data telegram, the transmitter being designed for manual operation at least if required, and that the locator transmitter includes a particular individualized code which is stored as data in the locator transmitter and which is received by the locator receiver after the activation of the transmitter of the locator transmitter.

Therefore, in the device according to the invention it is provided that a particular locator transmitter attached to the missing person or to the missing object is activated by a signal from the transmitter of the locator receiver. If the locator transmitter is activated, the same will send a data telegram which is received in turn by the locator receiver. The locator transmitter includes a particular individualized code that makes it possible to address the particular locator transmitter. This code is stored as a data set in the locator transmitter and is received by the locator receiver upon activation of the transmitter of the locator transmitter. The locating of the missing person or the missing object can then be effected on the basis of these data.

For the solution of the above-mentioned problem the method according to the present invention provides that the locator receiver emits through a transmitter a signal for the activation of a particular locator transmitter, which signal activates the locator transmitter to transmit the data telegram, with the transmitter being manually operated at least when required, and that the locator transmitter includes a particular individualized code which is stored as data in the locator transmitter and is received by the locator receiver upon activation of the transmitter of the locator transmitter.

Further features and advantages of the invention will become apparent from the dependent claims and from the following description of preferred embodiments of the invention.

According to a further feature of the device according to the invention it is provided that the locator receiver includes an identification generator by which the data enabling the locating can be output optically and/or acoustically. Such an identification generator can be for instance a display on which directional information can be displayed. This may happen for example by means of arrows indicating to the person carrying the locator receiver the direction of the received signal. Further, the data can be output also acoustically, for example by a signal with a varying sequence of notes, sound intensity and loudness, the variance being dependent of the orientation of the locator receiver and, accordingly, the person who carries the locator receiver is indicated the direction of and the distance to the targeted locator transmitter through the variance of the sound.

It is further provided that the locator transmitter is connected to a GPS receiver through which the data enabling the locating are generated. Through the GPS receiver or a receiver working in the same way the exact position coordinates of the locator transmitter to be located are detected via the locator transmitter and are transmitted to the locator receiver in the form of the data telegram, so that the person handling the locator receiver can visually detect the location of the locator transmitter through a map representation on the display. This configuration makes the search for the missing person or the missing object easier and possibly injured or unconscious persons who are equipped with a corresponding locator transmitter can be rescued more quickly.

Preferably, the transceiver and the receiving transmitter are designed as radio devices for the radiotelephone traffic, and the data are transmittable as data telegrams through these radio devices. This embodiment has the advantage that they can be simply incorporated in already existing radio systems of public safety organizations like the police, fire brigade or the like.

In addition to the transceiver the locator transmitter includes a micro controller and an electric power supply, particularly in the form of a battery and/or an accumulator. It is further provided that the locator receiver includes in addition to the receiving transmitter a micro controller or a mobile PC and a direction finding device, particularly a directional antenna.

Finally, the device according to the invention is outstanding by the fact that the individualized code consists of a country code, a receiver address of the searched locator transmitter and a sender address of the locator receiver as well as an instruction to be carried out.

The above-described device works according to the following method:

Each locator transmitter has assigned to it an unmistakable und unchangeable device number which is stored in the form of a particular frequency and/or code. After the locator transmitter has been switched on or activated, it changes to an energy-saving receiving mode and waits for being addressed by a search team that is equipped with a searching device and that is ready to be located, by transmitting its device number in the form of the frequency and/or code.

During the search for a missing person the appropriate frequency and/or code of the locator transmitter is generated through the micro controller by the receiving transmitter of the locator receiver in the form of a data telegram and is emitted. In addition to the code of the searched locator transmitter this data telegram also contains a code for an instruction to be carried out by the locator transmitter, said instruction leading to the activation of the locator transmitter and accordingly to the emission of a strong locator signal. Such a code may have the following structure:
LL EEEEEEE XX AAAAAAA
   wherein “L” contains a country code, for instance the sequence of the numbers “49” for German devices, “E” the receiver address of the locator transmitter, “X” the instruction to the locator transmitter to be carried out, and “A” the sender address of the locator receiver. Since each position can take up to 15 values, about 170 million device IDs may be allocated for each country. Instead of the defined device address consisting of country code and device address, it is also possible to send (in the case of an unknown device number) a group calling signal which causes all the locator transmitters at a particular frequency to carry out the instruction, particularly activating them to emit the locator signal.

If a locator transmitter receives its own identification sent from a locator receiver, the locator transmitter is switched from the receiving to the transmitting mode. During this, a data telegram is transmitted to the locator receiver including a confirmation of the activation of the locator transmitter on one side and the receiver address of the locator transmitter on the other side. Thereafter, the transmitted instruction is processed by the locator transmitter, and as a rule this instruction is an instruction to emit a locator signal for locating. This instruction may be supplemented to such an extent that for instance a GPS receiver is activated which generates the coordinates according to the geographical longitude and geographical latitude of the locator transmitter and incorporates this information in a data telegram which is then transmitted to the locator receiver which decodes the data telegram and displays the transmitted data on a display which for instance represents the exact location point of the locator transmitter in the form of a map, in dependence of the locator receiver. In addition, there exists the possibility that the locator receiver supplementary activates an optical and/or acoustical identification generator, so that there is emitted for example a sound signal or a flash light. This method had excellent performance in searching for missing persons and/or objects in areas with insufficient lighting.

In the practice the device and also the method of the present invention are particularly important for persons working in dangerous areas like for instance firemen and emergency aid operation teams trying to rescue other people after an earthquake under the risk of aftershocks. In such a case the rescue people themselves run the risk of getting into a dangerous situation, for example getting buried. To speed up the rescue of such persons each person carries a corresponding locator transmitter which can be activated by the locator receiver. Furthermore, the devices according to the invention may be used by alpinists and cave explorers.

A further field of use of the invention is with persons who live or work in regions jeopardized by earthquakes or with persons with a high risk of being kidnapped because of their position in the public. Since the activation of the locator transmitter does not require any activity by the missing person, the rescue operation can be initiated by third parties secretly and via radio locating. Corresponding locator transmitters can be provided in a size allowing the transmitter to be arranged in the clothes or also in the body of a person. The signal for the activation of a particular locator transmitter is especially designed as analogous or digital radio waves. As an alternative ultrasonic waves are conceivable enabling the use of the device or method also in the field of diving equipment.

Further features and advantages of the device and the method according to the present invention will become apparent from the following description of the attached drawing showing a preferred embodiment of the invention. In the drawing it is shown by:

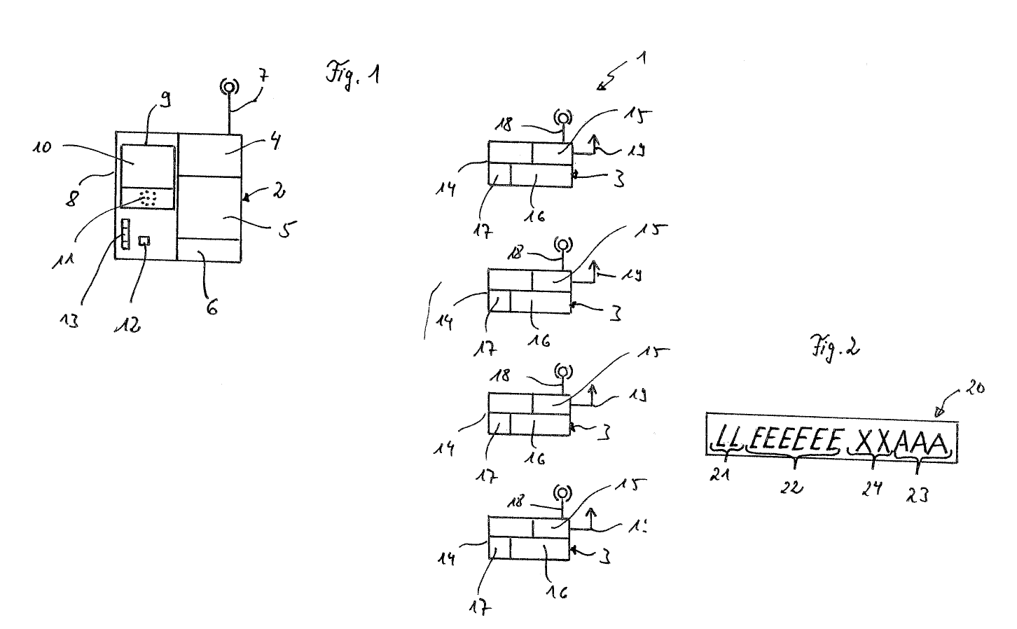

FIG. 1 a device for locating missing persons, said device consisting of a locator receiver and four locator transmitters;

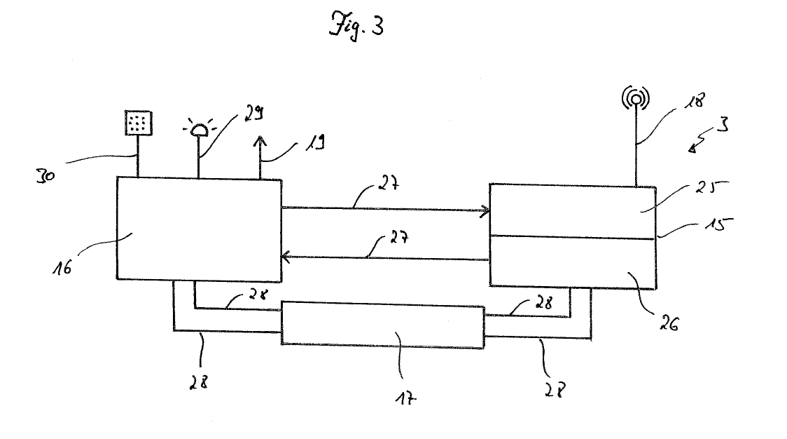

FIG. 2 a schematic representation of a coding of a locator transmitter; and

FIG. 3 a schematic representation of the locator transmitter of the device according to FIG. 1.

FIG. 1 shows a device 1 for locating missing persons and/or objects. The device 1 consists of a locator receiver 2 and several, in the present case four locator transmitters 3. The locator receiver 2 includes a transmitter 4, and the locator receiver 2 is designed as a receiving transmitter. The transmitter 4 has an antenna 7 through which a signal is emitted, but which is simultaneously suited also for the receipt of data in the form of locator signals.

The transmitter 4 is connected to a micro controller 5 which is supplied with energy from a battery 6. The micro controller 5 generates the data which are to be sent as a signal from the transmitter 4 and transmits these data to the transmitter 4. On the other hand, locator signals received through the antenna 7 are transmitted to the micro controller 5.

The micro controller 5, battery 6 and transmitter 4 are arranged in a housing 8 of the locator receiver 2. The housing 8 further includes an identification generator 9 having a display 10 as well as a sound generator 11. Through the display 10 the data enabling the locating can be optically output.

Furthermore, in the housing 8 a key 12 and an operating element 13 are arranged. Via said operating element 13 particular actions such as for instance the emission of a particular signal to a particular locator receiver can be selected and confirmed and triggered through the key 12. Thereby a particular locator transmitter 3 can be directly addressed from the locator receiver 2.

Each locator transmitter 3 includes a housing 14 having arranged therein a transceiver 15, a micro controller 16 and a battery 17. The transceiver 15 is connected to an antenna 18. Furthermore, the transceiver 15 includes a GPS receiver 19 through which location data of the locator transmitter 3 can be generated, supported by satellite.

In the transceiver 15 an individualized code 20 according to FIG. 2 is invariably stored. The code 20 consist of a two-digit country code 21, a multi-digit receiver address 22, a multi-digit sender address 23 as well as a two-digit code of an instruction 24 to be carried out.

In FIG. 3 the locator transmitter 3 is schematically represented. The locator receiver 15 consists of a transmitter 25 and a receiver 26 which are respectively connected to the micro controller 16 through a data line 27. The battery 17 which is shown in FIG. 3 supplies both the locator receiver 15 and the micro controller 16 with the required energy through energy lines 28.

In the embodiment according to FIG. 3 an optical signal generator 29 and an acoustical signal generator 30 are connected to the micro controller 16 in addition to the GPS receiver 19, with said optical signal generator 29 being designed as a flash light.

1. Device for locating missing persons and/or objects, which device consists of at least one locator transmitter with a transceiver and at least one locator receiver which is designed as a receiving transmitter and receives data telegrams sent from the transceiver and optically and/or acoustically displays the same as data enabling the locating,
characterized in
that the locating receiver (2) includes a transmitter (4) which for the activation of a particular locator transmitter (3) outputs a signal which activates the locator transmitter (3) to transmit data telegrams, with the transmitter (4) being designed for manual operation at least if required and
that the locator transmitter (3) includes a particular individualized code (20) which is stored as data in the locator transmitter (3) and is received by the locator receiver (2) upon activation of the transmitter (4) of the locator transmitter (3).

2. Device according to claim 1,
characterized in
that the locator receiver (2) includes an identification generator (9), by means of which the data enabling the locating can be output optically and/or acoustically.

3. Device according to claim 1,
characterized in
that the locator transmitter (3) is connected to a GPS-receiver (19) through which the data enabling the locating are generated.

4. Device according to claim 1,
characterized in
data telegrams sent from the transceiver and optically and/or acoustically displays the same as data enabling the locating,
characterized in
that the locator receiver (2) emits through a transmitter (4) a signal for the activation of a particular locator transmitter (3), which signal activates the locator transmitter (3) to transmit the data telegram, with the transmitter (4) being manually operated at least if required, and that the locator transmitter (3) includes a particular individualized code (20) which is stored as data in the locator transmitter (3) and is received by the locator receiver (2) after the activation of the transmitter (4) of the locator transmitter (3).

10. Method according to claim 8,
characterized in
that the locator receiver (2) includes an identification generator (9), by means of which the data enabling the locating are output optically and/or acoustically.

11. Method according to claim 8,
characterized in
that the data enabling the locating are generated through a GPS receiver (19) which is connected to the locator transmitter (3).

12. Method according to claim 8,
characterized in
that the data are transmitted as a data telegram through the transceiver (15) and the receiving transmitter which are designed as radio devices for radio telephone traffic.

13. Method according to claim 8,
characterized in
that the individualized code (20) is transmitted as a combination of a country code (21), a receiver address (22) of the searched locator transmitter (3) and a sender address (23) of the locator receiver (2) as well as an instruction (24) to be carried out.

14. Method according to claim 8,
characterized in
that the signal for the activation of a particular locator transmitter are emitted as analogous or digital radio waves or as ultrasonic waves.
